(19) United States
(12) Patent Application Publication
(10) Pub. No.: US 2026/0316458 A1
(43) Pub. Date: Oct. 15, 2026

(54) A METHOD OF PRINTING USING PRIMER, INK AND VARNISH

(71) Applicant: Canon Production Printing Holding B.V., Venlo (NL)

(72) Inventors: Nicolaas T.A. VAN RENS, Venlo (NL); Mike P. VAN EEKHOUT, Venlo (NL); Stan H.P. KERSTEN, Venlo (NL)

(73) Assignee: Canon Production Printing Holding B.V., Venlo (NL)

(21) Appl. No.: 19/466,678

(22) Filed: Feb. 2, 2026

Related U.S. Application Data
(63) Continuation of application No. PCT/EP2024/071853, filed on Aug. 1, 2024.

(30) Foreign Application Priority Data
Aug. 11, 2023 (EP) 23191044.9

(51) Int. Cl. B41J 2/21; B41J 2/07; B41M 5/00; B41M 7/00

(52) U.S. Cl. CPC B41J 2/2114; B41J 2/07; B41M 5/0017; B41M 7/0018

(57) ABSTRACT

A method of printing comprising the use. of:
a primer (16) to be applied to a substrate (10),
ink (22) to form an image on the substrate (10) after the primer (16) has been applied, and
a varnish (28) to form a layer that covers the image,
   characterized in that the primer (16) is only applied in areas of the substrate where the amount of ink (22) to be applied is above a predetermined threshold (T).

### BACKGROUND OF THE INVENTION

### 1. Field of the Invention

The invention relates to a method of printing which comprises the use of: a primer to be applied to a substrate, ink to form an image on the substrate after the primer has been applied, and a varnish to form a layer that covers the image, wherein the primer is only applied in areas of the substrate where ink is to be applied.

### 2. Description of the Related Art

In order to improve the quality of a printed image, it is common practice to apply a salt-based primer on the substrate before the image is printed thereon. In ink jet printing, the main purpose of the primer is to prevent feathering or inter-color bleeding of the inks. However, if a layer of varnish is later applied on the image in order to enhance the gloss, a portion of the salt contained in the primer may migrate into the ink layer and further into the varnish and may interact with the varnish. This may compromise the transfer of the varnish from an applicator roller to the printed image and may also hinder the leveling of the varnish. This may lead to a loss of gloss and/or a contamination of the applicator roller with salt.

The US 2013/061767 A1 discloses a method wherein the local amount of primer to be applied onto the substrate is varied dependent upon a number of factors which include among others the amount of ink to be applied locally.

Another method for mitigating the adverse effects of the salt in the primer as disclosed in WO 2020/049060 A1.

A method according to the preamble of claim 1 is disclosed in CN 114 559 744 A.

### SUMMARY OF THE INVENTION

It is an object of the invention to provide a method of the type indicated above, which is easy to implement and can improve the quality of the printed image.

In the method according to the invention, in order to achieve this object, primer is only applied in areas of the substrate where the amount of ink to be applied is above a predetermined threshold.

The invention takes advantage of the effect that, when liquid ink is applied on the layer of primer, a certain amount of salt, mainly from a surface layer of the primer, will be dissolved in the liquid ink and will react with the ink. As a consequence the salt will be become more and more diluted and neutralized when the applied amount of ink increases. Thus, when the layer of ink is sufficiently thick, it will shield the varnish from the salt. When the applied amount of ink exceeds a certain threshold, the salt becomes diluted and washed out to such an extent that no substantial interaction with the varnish is observed and the gloss of the image will not be degraded. On the other hand, if only a small amount of ink is to be applied, the concentration of salt at the surface of the image will remain high and may cause a loss of gloss of the varnished print. However, when the amount of ink is small, the tendency of the ink to bleed will also be reduced significantly, so that a high print quality can be achieved even without primer. Consequently, the undesired interaction of the salt with the varnish can be avoided simply by applying no primer at all if the amount of ink is below the threshold.

More specific features of the invention are indicated in the dependent claims.

### BRIEF DESCRIPTION OF THE DRAWINGS

An embodiment of the invention will now be described in conjunction with the drawings, wherein:

FIG. 1 is a schematic view of a printing apparatus which can be used for practicing the invention;

FIGS. 2-4 are schematic illustrations of a process of coating an image with a layer of varnish under different conditions;

FIG. 5 is a diagram illustrating a method for determining a threshold for an amount of ink; and

FIG. 6 is a flow diagram illustrating essential steps of a method according to the invention.

### DETAILED DESCRIPTION OF EMBODIMENTS

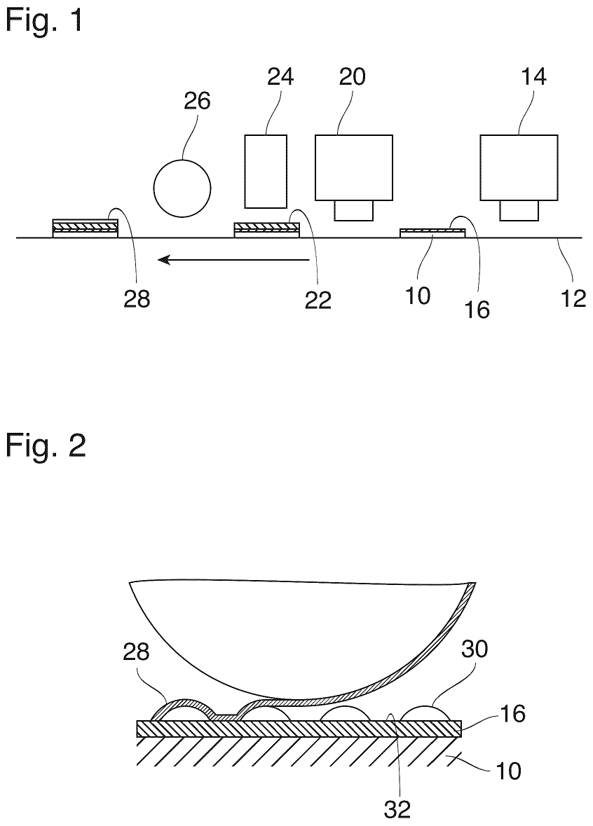

An ink jet printer that can be used for practicing the invention has schematically been shown in FIG. 1. Substate sheets 10 are transported on a conveyor 12 in the direction indicated by an arrow and move past a first ink jet print head 14 that is used for applying a primer 16, then past an ink jet print head assembly 20 for applying colored ink 22 so as to form an image on the surface of the primer layer, a curing station 24 for curing the image, and a coating station 26 for applying a layer of varnish 28 of the surface of the image.

The first ink jet print head 14 is capable of image-wise printing with primer, so that primer 16 may be applied only in certain areas of the image whereas other areas may be kept free of primer. Obviously, no primer needs to be applied in areas where no ink will be applied, neither. However, as will become clear as the description proceeds, there may also be situations in which it is preferable to apply no primer in certain areas of the substrate where colored ink is going to be applied later with the print head assembly 20.

FIG. 2 is a sectional view of a surface area of the substrate 10 where a layer of primer 16 has been applied and then a relatively small amount of ink has been applied by the print head assembly 20. Then, after curing, the layer of varnish 28 is roller-coated onto the surface of the image. The print heads of the print head assembly 20 apply the ink in the form of individual droplets 30, and because the amount of ink was small, the droplets have not coalesced but remain separated from one another by gaps 32 in which the layer of varnish 28 will come into direct contact with the primer 16. As result, a large amount of salt will migrate into the varnish layer so that there will be an undesired strong interaction between the salt and the varnish under these conditions.

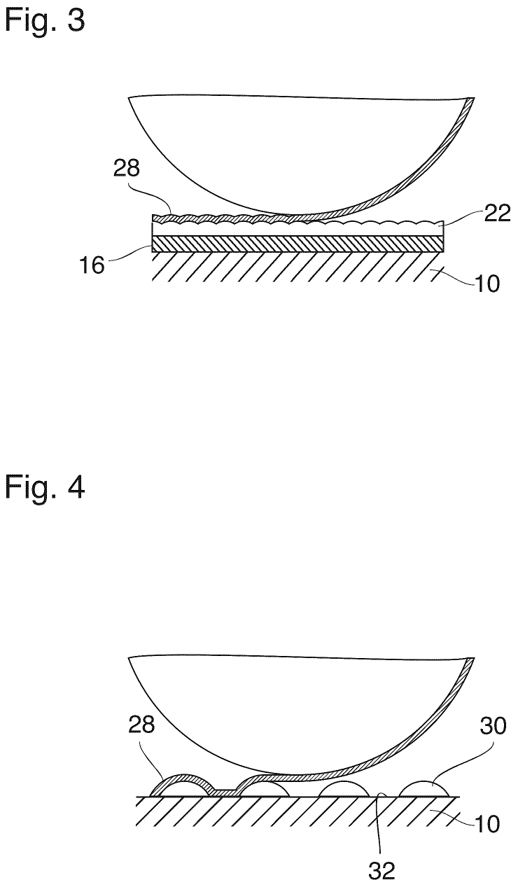

By contrast, FIG. 3 illustrates a situation where the amount of applied ink was substantially larger so that the droplets have coalesced and form a uniform layer of ink 22. In this case, the layer of varnish 28 will somewhat be shielded from the salt in the primer 16 by the continuous and relatively thick layer of ink. This will sufficiently suppress the interaction between the salt and the varnish, so that the adverse effects of the use of primer are avoided while, on the other hand, the primer 16 will effectively prevent the colored ink from bleeding.

If the amount of ink is small, as in FIG. 2, there will be no substantial tendency of the inks to bleed, because the droplets 30 are isolated from one another, anyway. Therefore, in this case it is preferable to dispense with the primer, so that the ink droplets 30 are applied directly to the surface of the substrate 10, as has been shown in FIG. 4. In the gaps 32 between the ink droplets, the varnish 28 will be applied directly to the surface of the substrate. However, since no salt is present on this surface in absence of the primer layer, the layer of varnish 28 will not be degraded, so that a high image quality can be achieved.

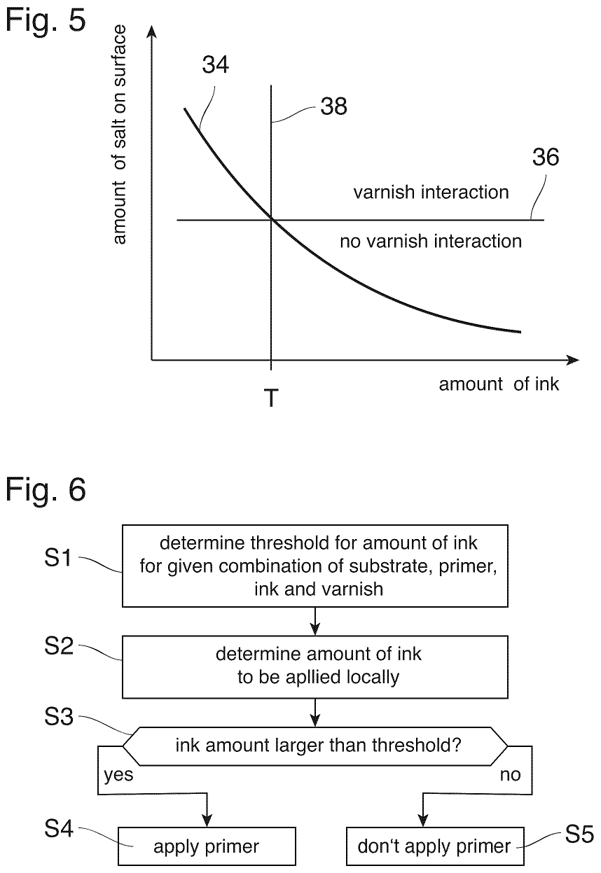

In FIG. 5, a curve 34 shows the amount of salt remaining on the surface of the printed and cured image as a function of the amount of ink per surface area that has been applied. Due to increasing dilution of the salt, the amount of salt will generally decrease with increasing amount of ink. The exact shape of the curve 34 will depend on the (absorption) properties of the substrate 10, the composition of the primer, and the properties of the ink(s) and may be determined experimentally for different combinations of substrates, primers and inks. In general, the salt present on the surface of the image will interact with the varnish. However, if the amount of salt is small enough, the interaction between salt and varnish will be negligible and will cause no visible artifacts in the varnished image. Therefore, in FIG. 5, a horizontal division line 36 separates a range of salt amounts, for which there will be varnish interaction, from a range of salt amounts for which there will be no substantial varnish interaction. The exact position of the separation line 36 will depend on the property of the varnish and may also be determined experimentally.

A vertical line 38 passing through the point of intersection of the curve 34 and the separation line 36 indicates a threshold T for the amount of ink above which there will be no substantial varnish interaction, so that the layer of primer may be left out.

Another example of a method to determine the lower limit T comprises printing a test card with a gray scale with ascending ink overlays. When this test card is printed with different values for T, it is possible to determine the threshold T by means of a gloss measurement.

FIG. 6 is a flow diagram summarizing the essential steps of a method according to the invention.

In step S1, the above-mentioned threshold T for the amount of ink is determined for a given combination of substrates, primer, ink and varnish. Then, in step S2, the amount of ink that will be applied on each location within the image area will be inferred from print data that specify the image to be printed. A subsequent step S3 is a step of comparing the amount of ink as determined in step S2 to the threshold T as determined in step S1. If the ink amount is larger than threshold (“yes”) a step S4 of applying primer will be performed. Otherwise, i.e. when the ink amount is larger than the threshold T, the step S4 will be omitted or, equivalently, the print head 14 will be controlled, in a step S5, to not apply any primer.

1. A method of printing comprising the use of:
a primer to be applied to a substrate,
ink to form an image on the substrate after the primer has been applied, and
a varnish to form a layer that covers the image,
wherein the primer is only applied in areas of the substrate where ink is to be applied,
characterized in that the primer is only applied in areas of the substrate where the amount of ink to be applied is above a predetermined threshold.

2. The method according to claim 1, wherein an ink jet print head is used for image-wise application of the primer to the substrate.

3. The method according to claim 1, wherein an ink jet print head assembly is used for image-wise application of the ink.

4. The method according to claim 1, wherein the layer of varnish is applied in a roller-coating station.

5. The method according to claim 1, wherein the threshold is determined by performing the steps of:
establishing a curve that indicates the amount of salt remaining on the surface of the printed image as a function of an amount of ink that has locally been applied to that surface, for a given combination of a type of substrate, a type of primer and a type of ink;
determining, for a given type of varnish, a separation line between a range of the amount of salt, where interaction with the varnish will occur, and a range where no interaction with the varnish will occur, and
determining as the threshold to be the value of the amount of ink where the curve intersects the separation line.

6. The method according to claim 2, wherein an ink jet print head assembly is used for image-wise application of the ink.

7. The method according to claim 2, wherein the layer of varnish is applied in a roller-coating station.

8. The method according to claim 3, wherein the layer of varnish is applied in a roller-coating station.

9. The method according to claim 2, wherein the threshold is determined by performing the steps of:
establishing a curve that indicates the amount of salt remaining on the surface of the printed image as a function of an amount of ink that has locally been applied to that surface, for a given combination of a type of substrate, a type of primer and a type of ink;
determining, for a given type of varnish, a separation line between a range of the amount of salt, where interaction with the varnish will occur, and a range where no interaction with the varnish will occur, and
determining as the threshold to be the value of the amount of ink where the curve intersects the separation line.

10. The method according to claim 3, wherein the threshold is determined by performing the steps of:
establishing a curve that indicates the amount of salt remaining on the surface of the printed image as a function of an amount of ink that has locally been applied to that surface, for a given combination of a type of substrate, a type of primer and a type of ink;
determining, for a given type of varnish, a separation line between a range of the amount of salt, where interaction with the varnish will occur, and a range where no interaction with the varnish will occur, and
determining as the threshold to be the value of the amount of ink where the curve intersects the separation line.

11. The method according to claim 4, wherein the threshold is determined by performing the steps of:
establishing a curve that indicates the amount of salt remaining on the surface of the printed image as a function of an amount of ink that has locally been applied to that surface, for a given combination of a type of substrate, a type of primer and a type of ink;
determining, for a given type of varnish, a separation line between a range of the amount of salt, where interaction with the varnish will occur, and a range where no interaction with the varnish will occur, and
determining as the threshold to be the value of the amount of ink where the curve intersects the separation line.
